(19) United States
(12) Patent Application Publication
(10) Pub. No.: US 2008/0039340 A1
(43) Pub. Date: Feb. 14, 2008

(54) Reverse Phase Protein Array, Protein Activation and Expression Signatures, and Associated Methods

(76) Inventors: Steven Kornblau, Nassau Bay, TX (US); Kevin Coombes, West University, TX (US)

Correspondence Address: BAKER BOTTS, LLP, 910 LOUISIANA, HOUSTON, TX, 77002-4995, US

(21) Appl. No.: 11/754,041

(22) Filed: May 25, 2007

Related U.S. Application Data
(60) Provisional application No. 60/803,347, filed on May 26, 2006.
(60) Provisional application No. 60/869,283, filed on Dec. 8, 2006.

(51) Int. Cl. C40B 30/10

(52) U.S. Cl. 506/12

(57) ABSTRACT

Protein activation and expression signatures and methods of obtaining and using protein activation and expression signatures for cancer classification, prognosis, and therapy guidance are provided. A protein activation and expression signature may be formed by a process comprising: assaying a plurality of samples with a protein array; clustering the assayed samples based on patterns; and generating a heat map.

### CROSS-REFERENCE TO RELATED APPLICATIONS

This application claims priority to U.S. Provisional Application Ser. No. 60/803,347 filed on May 26, 2006 and to U.S. Provisional Application Ser. No. 60/829,283 filed on Dec. 8, 2006, both of which are incorporated by reference herein.

### STATEMENT OF GOVERNMENT INTEREST

This disclosure was developed at least in part using funding from the Leukemia Society of America, Grant Number 6089, and National Institutes of Health, Grant Number PO1 CA-55164. The U.S. government may have certain rights in the invention.

### BACKGROUND

Classification of biological samples from individuals is not an exact science. In many instances, accurate diagnosis and safe and effective treatment of a disorder depend on being able to discern biological distinctions among cell or tissue samples from a particular area of the body. The classification of a sample from an individual into particular disease classes has often proven to be difficult, incorrect, or equivocal. Some methods, such as histochemical analyses, immunophenotyping, and cytogenetic analyses, only one or two characteristics of the sample are analyzed to determine the sample's classification. Inaccurate results can lead to incorrect diagnoses and potentially ineffective or harmful treatment.

Understanding cancer physiology and pathogenesis has traditionally focused on alterations at the DNA level that result in expression of genes that are aberrant in location, altered in level, or that harbor mutations. Regulation of protein levels and function, which may also significantly define the phenotype of a cancer cell, occurs at many levels including transcription, mRNA stability, translational regulation, and perhaps most importantly by post-translational modifications (e.g. phosphorylation, prenylation, ubiquiniation, and the like). High throughput technologies like comparative genomic hybridization (CGH) and transcriptional profiling provide important data on DNA and RNA levels, however functional consequences of these changes cannot be assessed, and confirmatory experiments need to be carried out. Expression arrays, measuring mRNA levels, are routine and informative for some of these alterations, but are unable to ascertain the actual level of proteins expression, and are completely unable to detect post-translational modifications of proteins (phosphorylation, farnesylation, ubiquitination). The development of reliable proteomic characterization is crucial for the more global understanding of cancer cell physiology and pathogenesis at the protein level.

Proteomics can be defined as the large-scale study of proteins, including their structure, function, and activation. Particular challenges are: that the proteome differs from cell to cell; changes dynamically over time; and that polymorphisms, splice variants, and post-translational modifications greatly expand the ascertainable variables for each protein. Attempts at proteomic characterization of leukemic cells have mainly used MALDI-TOF (matrix assisted laser desorption/ionization-time of flight) analysis after two-dimensional gel-electrophoresis. The available evidence is sparse but supports the importance of proteomic analysis of leukemias, for example, for class distinction, target identification, apoptosis initiation, and stem cell analysis. However, proteins characterized by these methodologies need to be identified and characterized by other means, and more comprehensive profiling is often hindered by excessive material requirements and by the time required to perform each analysis. These techniques are inadequate for high throughput analysis of primary patient samples.

Understanding the effect and functional significance of new targeted anti-cancer agents, directed at functional sites on proteins (often kinases) also requires novel technologies that allow for a sensitive, accurate, and moderate to high-throughput assessment of the target of interest. Assessing off target effects on proteins in the same or neighboring pathways will become part of a comprehensive activity profile of a drug. Application of the promise of functional proteomic analysis to the study of individual cases of cancer therefore requires a novel, reliable, sensitive, time-, cost- and sample-sparing as well as high-throughput functional proteomic technology.

Reverse phase protein (micro)-array (RPPA) is a new, sensitive, high throughput, functional proteomic technology that offers many of the advantages needed. It extends the power of immunoblotting to provide a quantitative analysis of the differential expression of active (usually phosphorylated or cleaved) and parental proteins. Proteins and their corresponding phosphoproteins can be assessed reflecting the activation state/functionality of a given protein. Furthermore, cell cycle and apoptosis can be assessed by measuring cyclins, p21, p27, cyclin dependent kinases, phosphohistones, or PARP cleavage and activated caspases, respectively.

With RPPA all samples are spotted at the same time making this method ideally suited for retrospective analysis of large numbers of specimens similar to the idea of gene microarrays. Compared to a conventional Western blotting, which uses protein from 5×10⁵ cells, RPPA requires nanoliters of protein lysate (pico- to femtograms of protein). Protein equivalent to 200 cells is printed per slide, per single antibody. Thus samples prepared from only 5,000-20,000 cells are sufficient to analyze 100 different protein targets and from the material previously required for a single western blot, 2500 slides (theoretically=2500 antibodies) can be printed. The printing precision and reliability of the RPPA technology are extremely high with low experimental variability. This is most likely due to RPPA internal factors and the greater precision of the RPPA technology as sample handling and preparation are similar to WBs. Inter-slide/array comparison was likewise very high. One emerging feature is that the greatest reliability and least variability are achieved when samples are assayed together on one array/slide. The very high correlation between replicate printings of the same sample on the same slide suggests that duplicate printing could be omitted to permit a greater number of individual samples to be printed on the same slide and to reduce costs. This also enables the analysis of a much larger number of proteins from each sample and makes this technique suitable for analysis of cell populations present in low numbers, such as stem cells or cancer cells that survive chemotherapy.

Total proteins and their corresponding phosphoproteins can be assessed reflecting the activation state/functionality of a given protein or activation state of an entire pathway (e.g. signal transduction pathway). This broader assessment of protein modification and activation of an entire network has the potential to recognize new meaningful protein and pathway interactions of known proteins and can lead to new discoveries.

### SUMMARY

The present disclosure, according to certain embodiments, relates to protein activation and expression signatures and methods of obtaining and using protein activation and expression signatures for cancer classification, prognosis, and therapy guidance.

According to one embodiment, the present disclosure provides protein activation and expression signatures formed by a process comprising: assaying a plurality of samples with a protein array; clustering the assayed samples based on patterns; and generating a heat map. The present invention also provides, methods for preparing a protein expression and activation signature comprising: obtaining protein sample from a patient; obtaining one or more of a protein expression level and a phosphorylation level corresponding to a protein being measured; clustering samples based on patterns of one or more of expression levels or phosphorylation levels; and generating a heat map using the clustering and the proteins being measured.

The present disclosure also provides microarrays comprising a plurality of samples or sets of samples, a positive control, and a negative control, wherein the samples or sets of samples are arrayed on the slide and each sample or set of samples is associated with a positive control or with a negative control or both. Methods for normalizing a signal from a microarray are also provided, which comprise generating a three-dimensional topographical map from a plurality of signals and correcting irregularities found in the three-dimensional topographical map, wherein the plurality of signals is from one or more of a negative control and a positive control.

The present disclosure also provides methods for analyzing a sample comprising: comparing a protein expression level or a phosphorylation level or both in a cell sample from a cancer patient to at least one reference protein expression and activation signature, wherein the difference or similarity between the protein expression level or a phosphorylation level or both of the patient and the at least one reference protein expression and activation signature is indicative of prognosis of the cancer in the patient.

Systems also are provided that comprise a first storage medium including data that represent a protein expression level or a phosphorylation level or both of one or more proteins in a cell sample of a patient; a second storage medium including data that represent at least one reference protein expression and activation signature; a program capable of comparing the protein expression level or a phosphorylation level or both to the at least one reference protein expression and activation signature; and a processor capable of executing the program.

Despite similar clinical features, there are many different types of primary acute myleogenous leukemia (AML). Complex pathways of proteins, that control how leukemic cells respond to signals from the body, regulate how rapidly cells multiply, die or mature into functional blood cells. Often, the amount or activity of these proteins is abnormal in AML cells, and this can affect the response to therapy. Previously, the level or function of these proteins could only be studied one at a time, but the methods of the present disclosure now allow the study of 100 different proteins using the same amount of material previously required to study one protein. The expression level or function of these proteins may aid in better prognosis of disease as well as more effective treatments.

Further with the methods of the present disclosure, better comparability of a greater number of samples can be achieved as more samples are handled under identical conditions on one array reducing experimental bias. The methods of the present disclosure thus provide the reproducibility, precision, sensitivity, and reliability of the system not achieved with other protein technologies to date.

By assessing the expression and activation of proteins, the methods of the present disclosure may aid in finding proteins that might serve as potential targets for new drugs for certain diseases and states of disease.

The features and advantages of the present invention will be readily apparent to those skilled in the art upon a reading of the description of the embodiments that follows.

### FIGURES

Some specific example embodiments of the disclosure may be understood by referring, in part, to the following description and the accompanying drawings.

FIG. 1 shows total Stat3 (upper panel) and p-Stat3 (Tyr705) (lower left panel) protein expression from 5 different patients. (Top row) newly prepared “clear” cell lysates from peripheral blood (PB) and bone marrow (BM). (Second row) “blue” lysates of the same specimen. (Third row), leukemia cell lines. (Fourth row), MDA-468+EGF, Jurkat+FAS ligand stimulation. Of note is the small to absent change of Stat3 in the control cell lysates. Sample arrangement in the p-Stat3 (Tyr705) slide is identical to the upper panel. The right lower panel shows the same control cell samples (same experiment) printed onto a different slide and probed for p-Akt473 clearly showing an increase in p-Akt473 level with EGF stimulation of MDA-468 cells (MDA) and decrease in Fas ligand treated Jurkat cells.

FIG. 2 shows dilution curves and log linear representation by MicroVigene. Analysis of representative curves from MicroVigene for blue and clear PB lysate samples from the same patient. Each spot represents a dilution of the sample. An optimized curve (green line) with standard deviations (blue line above and below is automatically plotted through the data points. The software program “fits” a linear curve (red straight line) onto the dilution curve and calculates a function. The EC 30 or 50 of that curve gives a log number which is used for processing of the data.

FIG. 3 shows sensitivity of RPPA. Protein lysates were prepared from the leukemia enriched fractions from two patients with simultaneously obtained blood and marrow samples at concentrations of 7 and 10 cells/nl. These lysates were printed onto RPPA and assayed with 6 antibodies. The relative signal of each is shown. For both patients the signal strength for each proteins was similar regardless of source. For both patients the signal strength of the 7 cell/nL sample was consistently lower than that of the 10 cell/nL sample demonstrating that the RPPA could detect quantities at a 3 cell difference.

FIG. 4 shows protein lysates that were printed in replicate on the same RPPA and probed with 6 antibodies. The correlation between the replicates is shown. Mean R²=0.9926; ERK1/2=0.9973, pMAPK (42/44)=0.9919, Stat3=0.9825, pStat3 (Thr 705)=0.9979, Akt=0.9920, pAkt (Ser473)=0.9941)

FIG. 5 shows a comparison of expression intensities of phospho-specific proteins showed no significant difference at initial preparation and after two freeze-thaw cycles, demonstrated here for p-p38.

FIG. 6 shows inter-array (same sample on different slides) and inter-experiment (same sample different preparations on same array) variability was low with coefficients of variation between 6-15% for 8 tested total and phospho-site specific ABs (same ABs as in FIG. 2. and p38, p-p38 as shown in FIG. 3).

FIG. 7 shows absolute protein quantification by RPPA. The upper panel shows a magnification of dilution curves from a protein/peptide reference RPPA slide. Below the RPPA slide section is the amount of protein determined from the log scale. Each spot in the graphics is plotted as the densitometric absorption number against the protein concentration of a dilution spot of a sample. Since the absolute protein concentration of purified AKT and p-AKT (S473) peptide are known, the unknown protein concentration of any lysates can be calculated according to the Akt standard curves.

FIG. 8 shows examples of HSC Analysis by RPPA. Several pairs of lineage positive and negative AML and normal bone marrow (NBM) are depicted.

FIG. 9 shows a schematic illustrating sample printing, according to one embodiment of the present disclosure.

FIG. 10 shows a representative slide, from phospho AKT Threonine 308, according to one embodiment of the present disclosure.

FIG. 11 illustrates a cluster diagram showing that protein expression was not correlated with clinical characteristics.

FIG. 12 illustrates mean levels of protein expression by disease status, according to one embodiment of the present disclosure.

FIG. 13 illustrates unsupervised clustering of samples, according to one embodiment of the present disclosure.

FIG. 14 illustrates bootstrap clustering of the sample data, according to one embodiment of the present disclosure.

FIG. 15 illustrates a heat map showing protein expression levels evaluated across FAB classification, according to one embodiment of the present disclosure.

FIG. 16 illustrates clustering pr sample data with different protein signatures being associated with particular cytogenetic changes.

FIG. 17 shows a heat map, according to one embodiment of the present disclosure, illustrating the average level of protein expression by evaluated in the context of cytogenetics.

FIG. 18 shows a heat map, according to one embodiment of the present disclosure, illustrating the average signal of each protein within 7 protein signature clusters. The components of 10 protein clusters are shown in the heat map.

FIG. 19 show the mean levels of example proteins by disease status, going from newly diagnosed to first relapse, primary refractory and second or greater relapse. Blue lines are blood and red are marrow.

The patent or application file contains at least one drawing executed in color. Copies of this patent or patent application publication with color drawing(s) will be provided by the Office upon request and payment of the necessary fee.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION

The present disclosure, according to certain embodiments, relates to protein activation and expression signatures and methods of obtaining and using protein activation and expression signatures for cancer classification, prognosis, and therapy guidance.

In general, the present disclosure relates to methods for classifying a sample according to the protein expression and activation signatures of the sample. In one embodiment, the present disclosure is directed to classifying a biological sample with respect to a phenotypic effect, e.g., presence or absence of disease or predicted treatment outcome, comprising the steps of determining a protein expression and activation signature of a cell sample, wherein the protein expression and activation signature is correlated with a phenotypic effect, thereby classifying the sample with respect to phenotypic effect. According to the methods of the disclosure, samples can be classified as belonging to (i.e., derived from) an individual who has or is likely to develop the disease of interest.

Alternatively, according to methods of the present disclosure, samples can be classified as belonging to a particular class of treatment outcome. That is, a sample can be classified as belonging to a high risk class (e.g., a class with a prognosis for a high likelihood of recurrence of disease, or a class with a poor prognosis for survival after treatment) or a low risk class (e.g., a class with a prognosis for a low likelihood of recurrence or a class with a good prognosis for survival after treatment). Duration of illness, severity of symptoms, and eradication of disease can also be used as the basis for differentiating or classifying samples.

In one embodiment, the present disclosure provides a protein activation and expression signature formed by a process comprising assaying a plurality of samples with a protein array; clustering the assayed samples based on patterns; and generating a heat map.

The samples are derived from patients having differing disease status. For example, the samples may include samples from patients that are newly diagnosed, primary refractory, first relapse, and second or greater relapse, and complete remission.

The sample may derived from the cells of patients with diseases relating to the level of expression and activation of proteins. Such diseases include but not limited to, cancer such as a solid tumor, metastatic cancer, or non-metastatic cancer, Acute Myelogenous Leukemia (AML), Acute Lymphocytic Leukemia (ALL), Chronic Lymphocytic Leukemia (CLL), Myelodysplasia (MDS), myeloma, and lymphoma. In other embodiments, the samples may be normal or malignant stem-cells, for example, human hematopoietic stem cells, leukemic cells, cells grown in an environment like the marrow, or cells surviving exposure to chemotherapy. The samples may be acquired from any source, including but not limited to, human cancer specimens, human leukemia specimens, stored AML lysates, and prepared cryopreserved cells. In one example, the samples may isolated by laser capture microdissection.

In certain other embodiments, human hematopoietic stem cells on a large scale may be analyzed using the methods of the present disclosure on a proteomic basis, and their protein expression and activation signature compared to bulk disease cells (e.g., leukemia cells). Since resistance and recurrence are likely to emerge from the stem cell population, analysis of this low abundance population may provide insights into mechanisms employed by stem cells to resist therapy and may suggest therapeutic targets. Furthermore, by assessing the protein expression and activation signature of proteins, the methods of the present disclosure may aid in finding proteins that might serve as potential targets for new drugs for certain diseases and states of disease.

The samples may be assayed with a protein array using antibodies specific to a protein. Examples of suitable proteins include, but are not limited to, signal transduction pathway (STP) proteins, apoptosis regulating proteins, cell cycle regulating proteins, cytokines, and chemokines. Specific examples of STP and apoptosis regulating proteins are listed in Table 1. Specific examples of cytokines and chemokines are listed in Table 2.

TABLE 1

| Signal Transduction | Apoptosis | Other |
|---|---|---|
| AKT, pAKT308 pAKT473 | BAD pBAD112 | Actin |
| | pBAD136 pBAD155 | |
| ERK2, pERk6 | BAK | B-Catenin |
| MEK, pMEK | BAX | CCND1 |
| p70S, P70S6K | BCL2 | DJ1 |
| PKCα pPKCα | BCLXL | MTOR, |
| SRC pSRC527 | MCL1 | pMTOR |
| pSTAT1 | SMAC | MYC |
| STAT3, pSTAT3-705 | Survivin | NRP1 |
| pSTAT3727 | | |
| pSTAT5431 | XIAP | S6, pS6.p2211 |
| pSTAT6 | | pS6RP.240-.244 |
| PTEN, pPTEN | | SSBP2 |
| P38 pP38 | | SSBP3 |
| p53 | | P27 |
| GSK3, pGSK3 | | |
| p53 | | |

TABLE 2

| Cytokines | Chemokines |
|---|---|
| Interleukins | Eotaxin |
| IL1B, IL1Ra | IP-10 |
| IL2, 3, 4, 5, 6, 7, 10, 12, 13, 15, 17 | IL8 |
| Growth Factors | MIP1a |
| G-CSF, GM-CSF | MIP1b |
| Angiogneic factors | Rantes |
| PDGFbb | MCP-1(MCAF) |
| FGF | SDF-1 (CXCL12/CXCR4) |
| VEGF | |
| TNFα | |
| TGFβ | |
| Interferon γ | |
| c-Kit | |

Other examples include mIR, Hox, and histone acetylation and methlyation levels.

The samples may be assayed using a protein array, such as a RPPA. RPPA uses a microdot blot like approach, printing protein samples onto a slide and probing them with a single antibody to generate a quantitative output. Total and phosphoproteins can be measured. The technique offers high sensitivity, throughput, and both inter and intra slide reproducibility. RPPA is particularly suited for use with STP proteins, apoptosis regulating proteins, cell cycle regulating proteins. Given the limitation of genomic arrays and conventional protein processing methods, protein microarrays like the RPPA have the potential to complement transcriptional profiling by offering a new means to quantify the expression level and activation status of cancer-associated proteins.

The present invention also provides microarray slide comprising a plurality of protein samples printed or sets of samples, a positive control, and a negative control. The samples or sets of samples are arrayed on the slide and each sample or set of samples is associated with a positive control and a negative control. In certain embodiments, the microarray also may include a normal sample, a cell line sample, and purified proteins.

The slide may be normalized for background and scale using the positive and negative controls. These controls provide a grid across the slide that can be used to measure background (e.g., from uneven staining). Not all slides will have perfectly even background across the slide, and the grid may be used to measure the background across the slide. By using the negative controls, a three-dimensional topographical map of background intensity may be generated and used to correct for background. This correction for background may be referred to as “topographical normalization.” Similarly, the three-dimensional grid of the positive controls may be used to set scale correction. Accordingly, the present disclosure also provides methods for normalizing a signal from a microarray comprising generating a three-dimensional topographical map from a plurality of signals and correcting irregularities found in the three-dimensional topographical map, wherein the plurality of signals is from one or more of a negative control and a positive control.

The data from each assay is clustered based on patterns, for example, using perturbation bootstrap validation/clustering. This clustering method factors in randomness and errors and allows for correction of biases, which increases the reliability of the data. Additionally, a Bonferoni correction may be performed to account for the number of samples and proteins/antibodies when calculating statistical significance. For example, clustering may be based on cytogenetic changes.

In one example, the assays may be clustered using principal component clustering based on the absolute value of Pearson correlation to define proteins clusters. In the case of AML, for example, this resulted in 9 proteins clusters. To define a protein signature, the score for each cluster for each patient was determined and an overall vector determined. When patients were clustered based on this overall score 7 proteins signature groups emerged.

A heat map of the clustered data may be generated. In this way, the data can be structured so provide prognostic and/or diagnostic information. A “heat map” or “heat map visualization” is a visual representation of a tabular data structure of protein expression or activation values, wherein color coding is used for displaying numerical values. The numerical value for each cell in the data table is encoded into a color for the cell. Color encodings run on a continuum from one color through another, e.g. green to red or yellow to blue for gene expression values. The resultant color matrix of all rows and columns in the data set forms the color map, often referred to as a “heat map” by way of analogy to modeling of thermodynamic data.

The term “color coding” refers to a software technique that maps a numerical or categorical value to a color value, for example representing high levels expression as a reddish color and low levels of gene expression as greenish colors, with varying shade/intensities of these colors representing varying degrees of expression. Color coding is not limited in application to expression levels, but can be used to differentiate any data that can be quantified, so as to distinguish relatively high quantity values from relatively low quantity values. Additionally, a third color can be employed for relatively neutral or median values, and shading can be employed to provide a more continuous spectrum of the color indicators.

In one example, a protein activation and expression signature heat map may be based on protein expression levels evaluated across FAB classifications. Such signature data could be used to suggest when to use targeted therapies. For example, an anti-BCL2 agent might be selectively used in M0, M1, and M2 where levels are high, and not in other FAB classifications where it is already low.

In another example, a protein activation and expression signature heat map may be based the average level of protein expression by cytogenetic category. Such signature data may be used to suggest that targeted therapies need to be applied selectively to those cytogenetics categories where expression or activation of that particular protein is found. For example, agents like nutlins would not likely be effective in cases with a −5 or −7 where p53 levels are very high.

In another example, a protein activation and expression signature heat map for AML may be generated. Such a heat map may show the average signal of each protein sample assayed within 7 protein signature clusters. Some of the resulting protein clusters may show positive correlation, while other groups may show both positive and negative correlation. Accordingly, the signature allows recognition of unique, recurrent patterns or signatures observed in AML. This may aid the selection of enhanced, individualized treatment plans.

Protein activation and expression signatures may be used to estimate the response rate of patients stratified by protein signature and cytogenetics. In the case of AML for example, all the favorable cytogenetic patients achieved remission so the signature was not informative; however, the remission and relapse rate varied for prognosis cytogenetics depending on the proteins expression signature. Further, the different remission and relapse rates associated with the different proteins expression signatures results in significant differences in overall survival within each cytogenetic category.

The present disclosure also provides a method for preparing a protein expression and activation signature comprising obtaining protein sample; obtaining one or more of a protein expression level and a phosphorylation level corresponding to a protein being measured; clustering samples based on patterns of one or more of expression levels or phosphorlation levels; and generating a heat map using the clustering and the proteins being measured. Such methods may be used to assess prognosis or diagnosis of a disease.

Further, a protein expression and activation signature of the present disclosure may be used in methods for classifying a protein sample with respect to a phenotypic effect, for example, presence or absence of a protein marker or predicted treatment outcome, comprising correlating a protein expression and activation signature with a phenotypic effect, thereby classifying the sample with respect to phenotypic effect. Such an approach accounts for the multitude of molecular defects often present in different cancers by profiling multiple signal transduction pathways simultaneously and defining a carcinogenic “fingerprint” specific to the patient. The samples can be classified as belonging to (i.e., derived from) an individual who has or is likely to develop the disease of interest. Alternatively, according to methods of the present disclosure, samples can be classified as belonging to a particular class of treatment outcome. That is, a sample can be classified as belonging to a high risk class (e.g., a class with a prognosis for a high likelihood of recurrence of disease, or a class with a poor prognosis for survival after treatment) or a low risk class (e.g., a class with a prognosis for a low likelihood of recurrence or a class with a good prognosis for survival after treatment). Duration of illness, severity of symptoms, and eradication of disease can also be used as the basis for differentiating or classifying samples.

In some embodiments, protein expression and activation signatures that classify cancer by type or response may be identified, and this may help better predict how a patient may respond to a certain treatment for the cancer. For example, patients with low probabilities of responding to conventional therapies may be treated with novel agents or stem cell transplants earlier during treatment. In these embodiments, the patterns of expression that classify cancer by type or response may be different activation states of key signal transduction pathway, apoptosis, cell cycle regulating proteins, cytokines, and chemokines.

A protein expression and activation signature also may be used to devise an individualized treatment regimen for the patient. In this way, a therapeutic agent may be rationally allocated to a patient depending on the expression or activation signature for that particular patient. Furthermore, as targeted therapies become available, determination of active protein pathways could be utilized to select targeted therapies most likely to be effective based on the classification and protein expression signature of an individual patient.

To facilitate a better understanding of the present invention, the following examples of specific embodiments are given. In no way should the following examples be read to limit or define the entire scope of the invention.

### EXAMPLES

In 85% of AML patients, a bone marrow collected 14 days after start of induction chemotherapy will reveal an empty marrow with “too few cells to count.” Despite this “empty” marrow some patients will show leukemia regrowth within a few weeks, while others will achieve remission only to relapse later. This regrowth must arise from the rare leukemia cells remaining after chemotherapy (“survivor cells”) and these cells must possess stem cell characteristics. This raises the question of whether the expression/activation pattern observed in stem cells is similar or distinct from the pattern of the bulk leukemia cells.

Peripheral blood, leukopheresis, or bone marrow specimens were collected prospectively from patients with newly diagnosed AML evaluated at The University of Texas M. D. Anderson Cancer Center between Sep. 1, 1999, and Jan. 1, 2004. Samples were acquired during routine diagnostic assessments in accordance with the regulations and protocols sanctioned by the Investigational Review Board of M. D. Anderson.

Generation of a Leukemia Enriched Fraction

Samples were placed on ice immediately after collection and were processed fresh within two hours of collection. A leukemia cell-enriched fraction is generated by isolating the mononuclear cell fraction by Ficoll-Hypaque separation (Mediatech, Hearndon, Va.) followed by the depletion of CD3+/CD19+ B- and T-cells by magnetic antibody-conjugated sorting (Miltenyi Biotec, Auburn, Calif.), as previously described. The cells were used fresh to make whole-cell lysates for Western blotting or RPPA arrays. To assess stability of phosphoepitopes, cryopreserved cells were thawed, kept at room temperature for 2 hours, and an aliquot lysed for RPPA. The remainder of the cells was refrozen. The same cycle was repeated once. Cells were then prepared in the usual fashion for RPPA.

Generation of CD34+/CD38− “Stem Cell” Fractions

To isolate a “stem cell” enriched fraction CD34+ cells were purified from the leukemia enriched fraction described above by MACS (Miltenyi, Biotech Inc., Auburn, Calif.) and then separated into CD34+/CD38− and CD34+/CD38+ fractions by flow sorting after incubation with anti-CD34, anti-CD38 antibodies and IgG controls (Becton Dickinson, San Jose, Calif.). Cells displaying greater fluorescence intensity than their controls were considered positive. An aliquot of sorted cells was reanalyzed for purity. Sorted and separated cells were lysed in RPPA lysis buffer as described below.

Cell Lines

Leukemia cell lines (U937, HL60, OCI-AML3, KG-1, Mo7e, TF1), obtained from ATCC, were grown in RPMI 1640 medium supplemented with 0.5% or 10% fetal bovine serum, 100 mg/nL Penicillin/Streptomycin, 4 nM Glutamate (all Gibco, USA). Cells were kept at subconfluent levels until harvest, then washed twice in ice cold phosphate buffered saline (PBS) and lysed in either of the above lysis buffers for 20-30 min, centrifuged at 14.000 RPM and the pellet was discarded. Cell lysates were diluted as described below in the RPPA section.

Western Blot

Western immunoblotting analyses were performed using material from 4-5×10⁵ cells and the Biorad Criterion system (Biorad, Hercules, Calif.), with bone marrow and peripheral blood samples loaded on the same blot with control cell lines (K562 and Jurkat cells) and molecular-weight markers as previously described. Numerous Western blot studies have shown that these samples are free of protein degradation (assessed by absence of actin laddering) and that the phosphoprotein status remains stable for at least a decade (for retinoblastoma protein).

Validation of Antibodies

One of the limiting factors in protein-biochemistry is the availability and quality of antibodies (ABs). Each candidate antibody was subjected to a stringent validation procedure before being certified for use by RPPA. The AB has to have a predominant single band in WB against cell lines and patient samples and not have any nonspecific binding. It is acceptable if the AB recognizes known cell characteristics, including size variants due to cleavage, mutation, or deletions. Antibodies against phosphorylated epitopes had to demonstrate specificity against samples stimulated (e.g. growth factors) or inhibited (specific inhibitors) to yield phosphorylated or non-phosphorylated forms of a protein. Alternatively, genomically altered cells, (e.g. transfected or siRNA inhibited) and cell lines could be used to validate ABs. Finally, for antibodies passing the above criteria, results by RPPA had to parallel those seen by WB.

RPPA

For quantification purposes protein cell lysates were serially diluted (6 or 8 serial dilutions: full strength, 1/2, 1/4, 1/8, 1/16, 1/32, 1/64, 1/128) with additional lysis buffer immediately prior to array preparation in 98 well plates. Dilutions were done with multi-channel pipettes by hand. Diluted samples were transferred into 384 well plates and heated at 95° C. for 10 min. From these plates the lysate material was printed onto nitrocellulose coated glass slides (FAST Slides, Schleicher & Schuell BioScience, Inc. USA, Keene, N.H.) with an automated robotic GeneTac arrayer (Genomic Solutions, Inc., North Bellerica, Ann Arbor, Mich.). Up to 24 identical slides can be printed at one time. The RPPA transfer method employed is a non-contact method where approximately 1 nL of protein lysate (corresponding to 10 cell equivalents from full strength protein lysate) is transferred to the nitrocellulose glass slide per array pin touch. The protein concentration spotted onto the glass slides can be adjusted by varying the number of pin touches from 5 to 10 per dot-spot (corresponding to 100 down to 0.8 cell equivalents after 8 serial dilutions), depending on the original protein concentration in a sample set. Up to 1152 single dots can be printed onto one slide. Each spot on the array slide represents a certain dilution of the lysate of a particular sample. If 6 serial dilution steps are used, as many as 192 samples can be spotted on a single slide. Once printed, the slides are stable at −80° C. and stainable for at least 6-12 months. Diluted protein printing plates (384 well plate) are storable at −80° C. for at least 12-18 months and can be used for multiple repeated printing processes of new array slides from the same original samples.

Probing

After slide printing the same stringent conditions for slide blocking, blotting, and antibody incubation used for immunoblotting are applied. First the microarray slides were blocked for endogenous peroxidase, avidin, and biotin protein activity prior to the addition of the primary antibody. The DAKO (Copenhagen, Denmark) signal amplification system was used to detect and amplify AB-binding intensity. This commercially available catalyzed system kit uses 3,3′-diaminobenzidine tetrachloride (DAB) and catalyzed reporter deposition of substrate to amplify the signal detected by the primary antibody. A biotinylated secondary antibody (anti-mouse or -rabbit) is used as a starting point for signal amplification. A streptavidin-biotin complex attached to the secondary antibody and biotinyl-tyramide deposition on this complex will be used to amplify the reaction. Tyramide-bound horseradish peroxidase cleaves DAB, giving a stable brown precipitate with excellent signal-to-noise ratio. This technique is sensitive and reproducible to the femtomolar sensitivity range.

Signal intensity was measured by scanning the slides with the ImageQuant (Molecular Dynamics, CA) and quantified using the MicroVigene™ automated RPPA module (VigeneTech Inc., MA). Using MicroVigene software the intensity of each spot is calculated and an intensity concentration curve is calculated with a slope and intercept. This allows relative quantification of each sample if the expression intensities are compared to a reference standard curve generated from control lysates, and absolute quantification can be determined by comparison to known quantities of purified peptides. The ratio of signal intensity from phosphorylated and nonphosphorylated antibodies allows for relative quantification of the activation state of a given protein across samples. Differences in loading was assessed and corrected for by normalizing expression intensities as described in the results section. For differentially regulated proteins, immunoblotting (WB) was performed to confirm results. To establish the use of human leukemic cell lines and primary specimens for RPPA analysis we systematically addressed and validated each experimental step of RPPA. The Leukemia Sample Bank (LSB) at MDACC has systematically stored hundreds of AML patient protein samples over the past 15 years. Complete outcome data is available. Therefore, we tested existing LSB protein samples with RPPA.

Utility and Sensitivity of RPPA

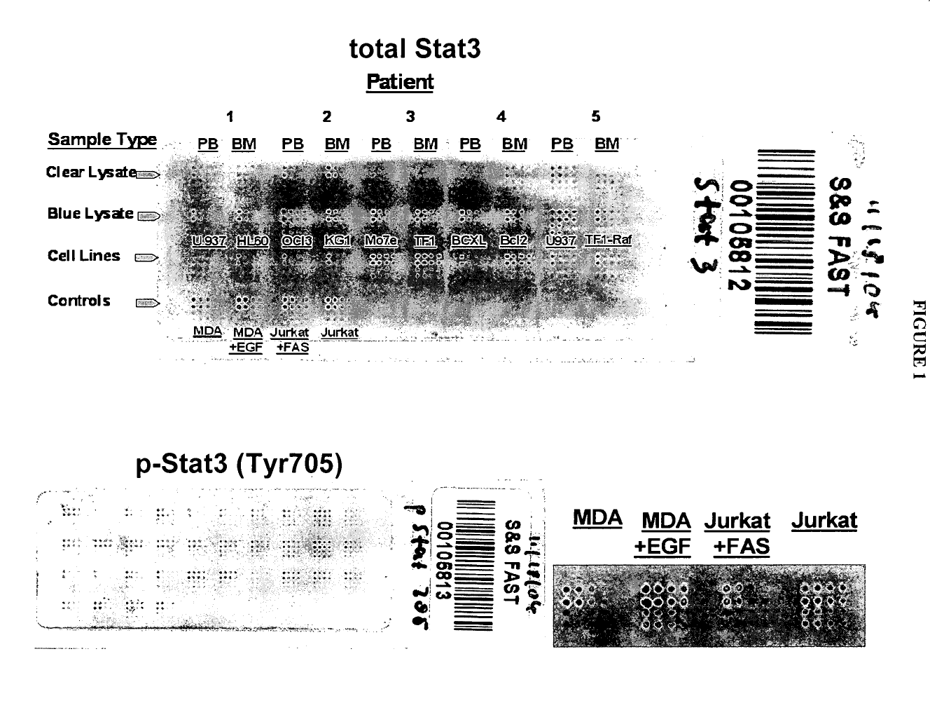

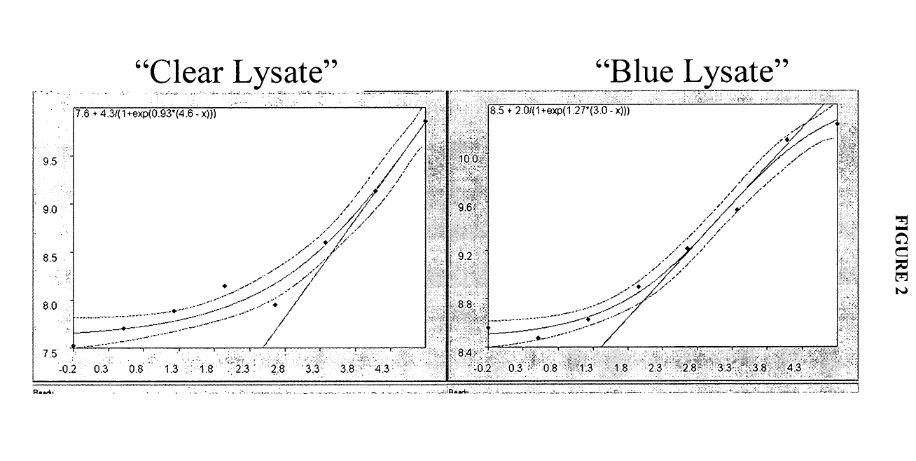

Cell lysates in the LSB are prepared using a WB lysis buffer containing bromophenol blue (called “blue” lysates) at a cell concentration of 10 cell equivalents per nL. Samples are aliquotted into single use vials containing 50 μL before freezing. To assess if the prepared, stored and ready to use WB blue lysates could be analyzed by RPPA we compared these with newly prepared cell lysates (“clear lysates”) using cryopreserved specimens from the same patient and the same date prepared at a concentration of either 7 or 10 cells/nL. Both “blue” and “clear” lysates gave strong signals in the linear part of the dilution curve (FIG. 2) that were analyzable for data evaluation (FIG. 1). Intrapatient variability between “clear” and “blue” lysates was minimal. Slides in FIG. 1 give an example of phospho-protein staining from patient samples stained for Stat3 and p-Stat3 (Tyr705). Peripheral blood (PB) and bone marrow (BM) samples obtained on the same day from 5 different patients are printed in alternating columns with the first row being from the newly prepared “clear” lysates and the second row from the existing “blue” lysate. The stronger signals in the second row, relative to the top row, are due to higher cell numbers per nL in the original sample for blue lysates versus clear lysates. In conclusion, the bromophenol blue of the WB lysis buffer did not interfere with signal detection and analysis as illustrated in FIG. 1, indicating that the existing protein lysates in the LSB can be used for RPPA.

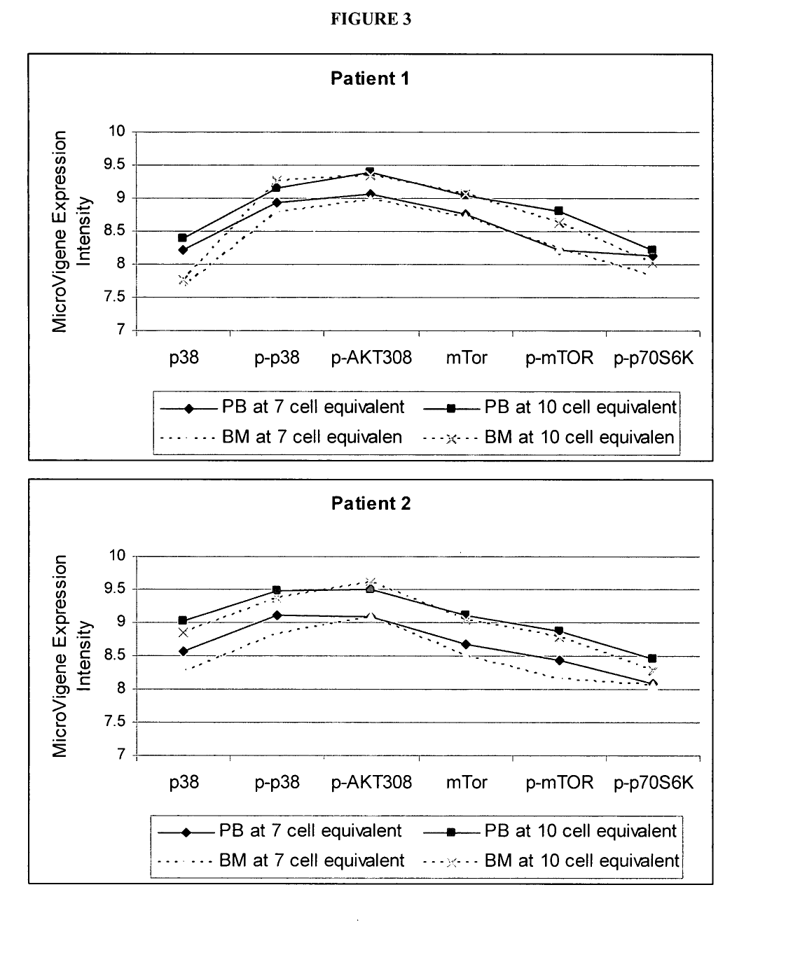

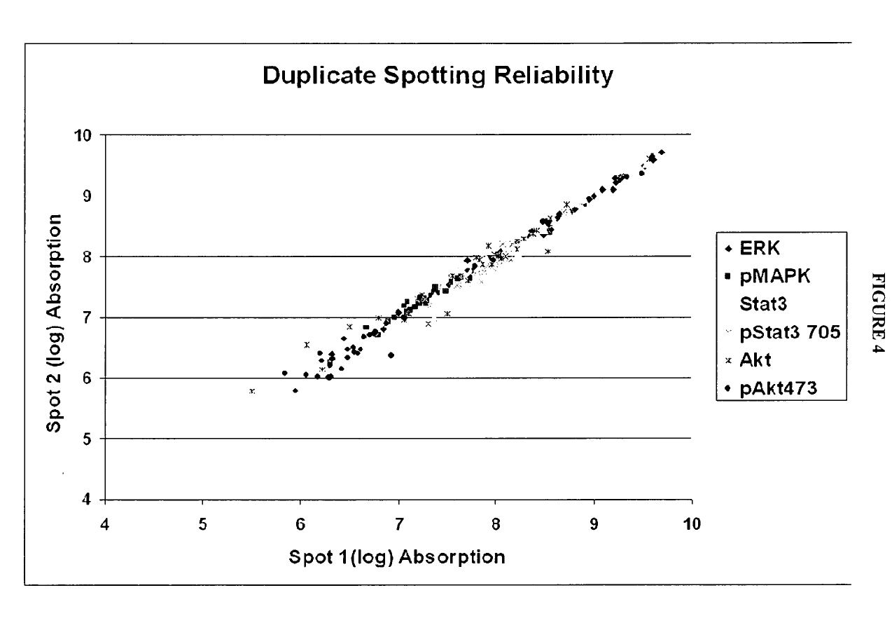

To detect the limit of resolution and the sensitivity in terms of the smallest detectable difference in cell numbers, we prepared cell lysates at 7 and 10 cell equivalents per nL, respectively. Arrays were printed with 10 touches and probed with 6 different antibodies as shown in FIG. 3. The curves from PB or BM derived material are superimposed suggesting equivalency of source material as previously reported. The minimal difference of 3 cells/nL between the 7 and 10 cell/nL preparations (equaling 30 cells per dot) between the two samples could readily be detected in all samples for all 6 different ABs confirming the quantitative nature of the assay. In experiments where the most concentrated sample had either 1000 or 500 cell equivalents per dot, and where the 8^{th} dilution contained protein form 8 and 4 cells respectively, we were able to detect a difference in signal intensity. The smallest numbers of cells from which protein was reliably detectable was 3 cells.

The sensitivity of RPPA was demonstrated by the ability to detect protein expression in primary samples at levels down to the femto-molar range using comparison to know purified protein preparation standards. 100 different phospho and total peptides have been obtained sufficient for quantification of 1000s of patient samples. The peptides can be arrayed on each slide allowing reference peptide curves from each array. The ability to detect expression in as few as three cell equivalents and to reliably detect differences in expression intensities between as few as 3 cells demonstrates the robustness and sensitivity of the RPPA system. Neither WB, nor MALDI-TOF achieves this sensitivity on a large scale basis. Immunohistochemistry assesses single cells, but is not suitable for a large scale comparison of many cells for many proteins. Fixation and protein stability are issues and the entire proteome is not as reliably represented as with RPPA. RPPA is a complementary, high-throughput screening tool, where individual results can be confirmed and expanded on with IHC or other methods.

Protein- and Phospho-Epitope Stability

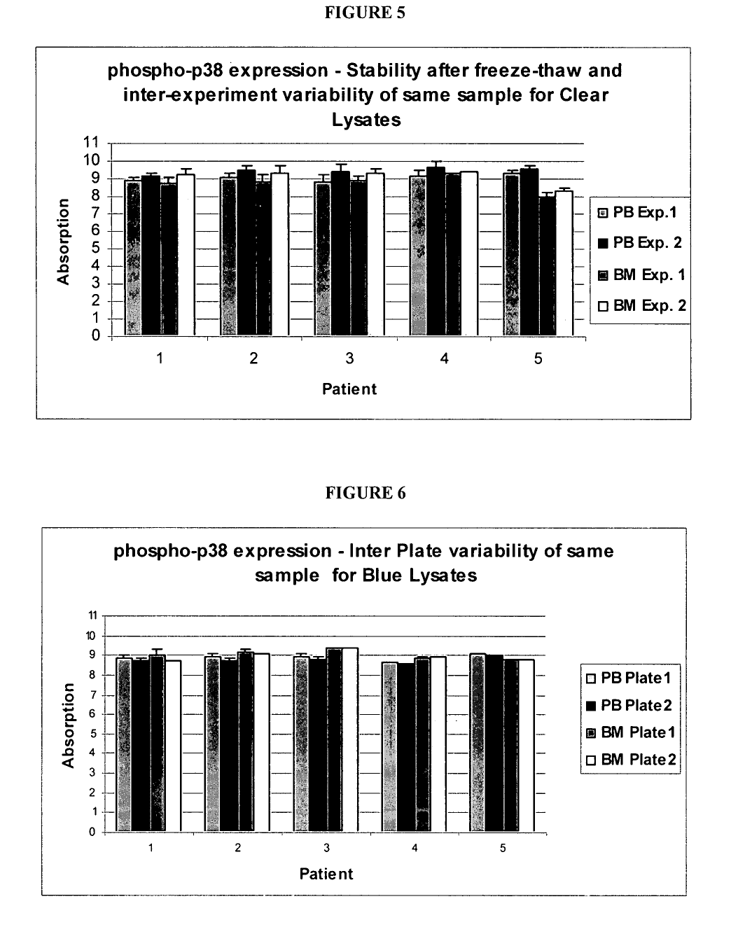

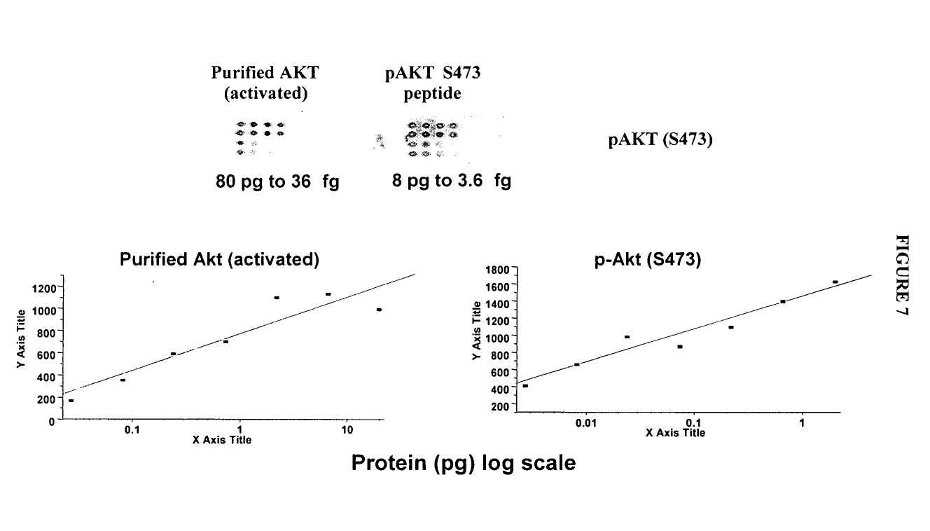

To assess phosphoepitope stability we tested whether the handling of cells used to generate protein affected phosphoprotein detection. Vials of cryopreserved blood and marrow derived cells, obtained on the same day from a patient, were thawed and a portion was removed to make a whole cell lysate, and the remaining cells refrozen. This was repeated for 2 cycles after which a second lysate was prepared. These Freeze-thaw specimens, along with the freshly prepared lysate, were printed onto slides and probed with eight total and phospho-proteins: ERK1/2, p-MAPK 42/44, Stat3, p-Stat3 (Thr 705), Akt, p-Akt (Ser473), p38, p-p38 (Thr180/Tyr182). There was no statistically significant difference in phosphoepitope expression intensity between the freshly prepared blue lysate and the samples prepared from cryopreserved derived samples (either PB or BM) from the first or third thawing. (FIG. 5 and FIG. 6). Similar levels of expression of (phospho)-proteins were observed in PB and BM samples (except patient 5) consistent with our findings using WB or Flow cytometry, indicating that leukemia enriched PB and BM samples can be used in the same analysis when only one is available. The above observation was further confirmed in a third sample set of 23 AML samples with simultaneously collected PB and BM samples. Expression profiles of these specimens showed no statistically significant difference between PB or BM from the same patient on unsupervised hierarchial clustering (p=0.67 for 23 samples and 37 antibodies).

The stability of phosphoepitopes over time was demonstrated by the similar findings obtained from freshly prepared protein samples made from cryopreserved cells when compared to protein samples prepared from the same specimen years before and stored at −70° C. since preparation. Furthermore, these results demonstrated that phosphoprotein epitopes in cryopreserved cells were relatively stable to repetitive freeze-thawing and to variability of specimens processing. This is important to know as it increases the confidence in the results of AML profiling.

Reproducibility and Precision of Printing/Spotting

To assess the reproducibility and variability of RPPA, the variation between lysate preparations, as well as the variation between plate and experiment setups and array runs, was tested (inter- and intrasample and intra- and interarray variation).

First to test the effect of array set up and preparation, the same lysate was prepared twice (two array plates) and printed onto the same array slide (inter-plate preparation). High correlations (R²=0.89-0.97) were observed. We next tested the variability of preparing new lysates from the same leukemia specimen (interexperiment). Again, when printed on the same array, high correlations (R²=generally from 0.79-0.96) were observed, demonstrating reproducibility within protein lysates production. Lastly, inter-array comparison (the same sample spotted onto different slides) is high, with coefficients of variation ≦15%. Assayed proteins in all experiments were: p38, p-p38, Stat3, p-Stat3 (Tyr705), ERK, p-MAPK 40/42, m-Tor, p-mTOR (Ser2448), p-AktS473, p-p70S6kinase (Thr389).

Duplicate spotting, (printing the same sample from a plate twice onto the same slide), is used by most groups but reduces the number of different samples that can be printed on a single slide. The correlation between duplicate spots was tested for 6 different antibodies and extremely high concordance was observed (Mean R²=0.9926; ERK1/2=0.9973, pMAPK (42/44)=0.9919, Stat3=0.9825, pStat3 (Thr 705)=0.9979, Akt=0.9920, pAkt (Ser473)=0.9941) (FIG. 4). This lack of variability suggests that duplication is not necessary.

Protein Quantification

To accurately determine the absolute concentrations of proteins in a sample, we currently generate standard signal intensity-concentration curves for purified proteins or recombinant peptides of known concentration for comparison with the samples in which protein concentrations are unknown. Using these peptide standard-reference curves the unknown protein concentration of each samples/lysate can be calculated. First the protein concentration for control cell lysates printed onto each slide (e.g. U937, HL60, Jurkat), is determined to serve as reference point for the signal intensity of “a slide.” Each slide can then be normalized to the protein expression intensities of the control cell lysates. From that, the absolute protein concentration can be determined reading off the peptide standard curve. An example is shown in FIG. 7. Purified activated Akt protein and p-Akt 473 peptide were arrayed by RPPA. Signal intensity (Y-axis) versus protein concentration (Protein (pg) log scale) was plotted. There was a linear relationship between the concentrations of purified activated AKT and phospho-AKT peptides and signal intensity. The RPPA assay detected activated AKT protein to picogram and phospho-AKT peptide to femtogram levels complementing our observation of the ability to detect minimal differences in cell numbers or protein concentration.

Analysis of Hematopoetic Stem Cells by RPPA

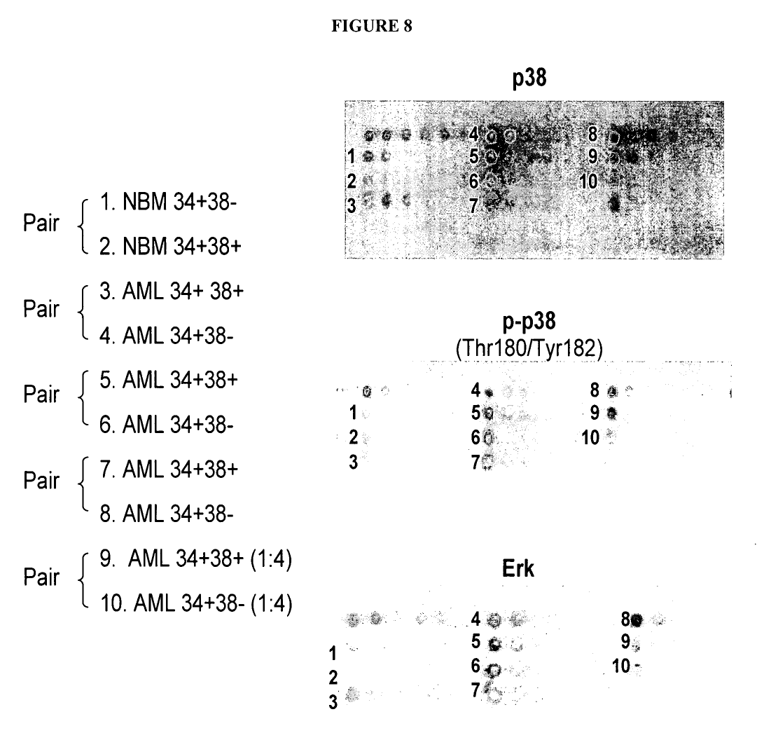

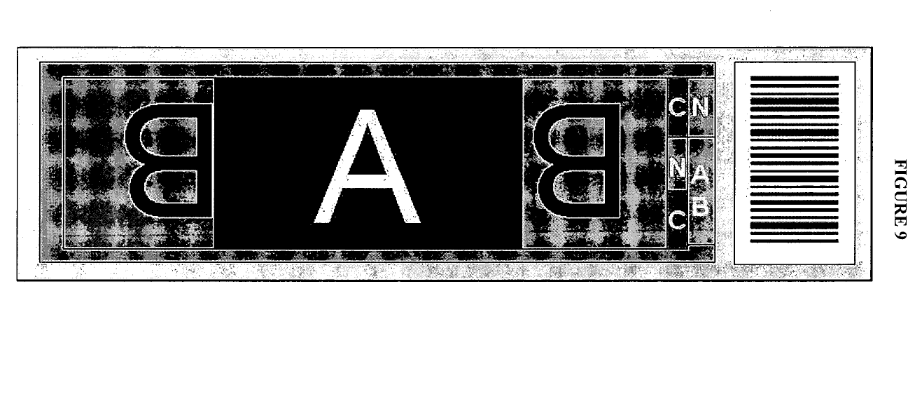

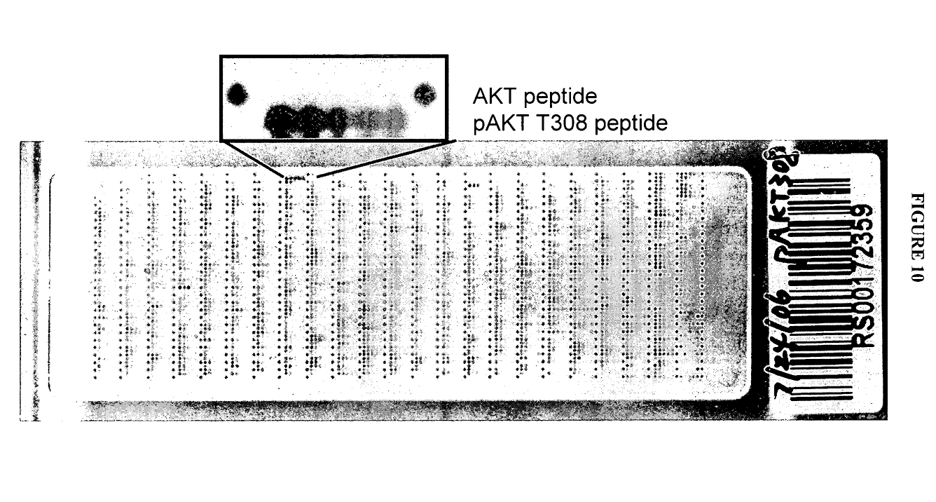

Most analyses of protein expression in leukemia utilize the bulk population of leukemic cells in the marrow or blood, rather than the rare stem cell population. An unresolved question is whether protein expression in stem cells is similar or distinct from that of the bulk population of leukemia cells. Since only 10-20,000 LSC or HSC can realistically be isolated from a sample (0.001% of 1×10⁷ cells=10,000 stem cells) traditional methods (WB, Flow) have not been able to analyze protein expression in stem cells. In contrast, a single slide for RPPA analysis requires only ˜200 cells protein equivalents, for a series of 8 dilutions, making RPPA ideally suited to analysis of low abundance populations of cells and 10-20,000 stem cells would provide sufficient lysate to allow for printing of 50 to 200 slides (equals 50 to 200 different AB's) from one sample. This number could be doubled using flurochrome probes Cy3 and Cy5 for each slide. As a pilot we generated protein lysates from isolated CD34+/CD38− stem cells, CD34+/CD38+ cells, CD34+ cells and the bulk leukemia cell population. FIG. 8 gives several examples of lineage positive and negative (CD 34/38) HSC assayed by RPPA and probed with various ABs. Results have shown that HSCs have a different protein signature compared to normal SCs (data not shown).

Correlation of RPPA with Western Blotting and Immunohistochemistry

The correlation of RPPA with conventional techniques was assessed in human leukemia cell lines U937 and NB4. Cells were incubated with varying doses of cytarabine alone or in combination with idarubicin. Cells were lysed and analyzed at varying time points and probed by RPPA and WB. Expression levels with RPPA were highly correlated with expression levels determined by Western Blotting. There was excellent correlation between WB and RPPA results with correlations coefficients were between R²=0.89-0.98 for Akt, p-Akt (473), Erk, p-Erk (42/44), Bcl-2 (data not shown).

Approach to Data Normalization and Loading Control

Inter-Array Comparison. One challenge in array analysis is the variability and comparability of staining between arrays (inter-array). One approach to increase inter-slide is to run positive controls, consisting of unstimulated, stimulated and inhibited cell lysates (e.g. MDA-468±EGF, U937, HL60, Jurkat±FAS or mixtures of cell lysates) on each slide. These serve as a reference point for the signal intensity of “a slide.” Individual samples can be compared relative to the average slide intensity as well as in relation to the intensity of a particular sample on a slide stained for a different antibody. Thus cross-comparison of samples and antibodies from distinct arrays can be compared.

Once a signal intensity of a sample (corrected for varying parameters) is determined, the absolute concentration can be determined from the peptide standard curve, similar to an ELISA assay. Alternatively if only relative protein expression levels are compared and numbers for absolute protein concentrations are not required, a set of samples/slides/experiments can be compared based on correction for the difference in signal intensity to the control cell lysates only. We routinely use both approaches depending on the specific question.

Protein Loading Correction/Normalization

Protein loading affects signal intensity. To correct for printing, AB binding/detection and staining variability, we aimed to develop a protein loading correction method. The necessity for this is supported by the observation that unsupervised hierarchical clustering of different samples sets (cell lines, primary samples, stem cells) arranges samples according to their corresponding set. The samples cluster according to their protein loading rather their true value for individual proteins expression intensity.

Therefore a protein loading/normalization approach was developed in a set of 96 primary AML samples. Surprisingly, the commonly used WB “housekeeping” proteins like Actin and GAPDH showed large variations amongst samples. This is not as surprising as we have made similar observations of leukemic samples analyzed by WB for Actin and GAPDH. A potential explanation is that WB membranes are saturated with proteins including Actin and GAPDH. Abundance of the added antibodies yields homogeneously dense bands on WB. The more sensitive RPPA can detect differences over a 3-4 log range whereas the range is 1.5 log for a typical WB. Protein-AB binding and concentration relationships are not assayed at their saturation in RPPA allowing detection of protein concentrations in the linear range depicting variations in Actin or GAPDH staining.

Similar to transcriptional arrays we aimed to compare different ways of correcting for loading using new housekeeping proteins. Empirically, we observed that 5 AB did show relatively stable expression across samples across slides (mTor, Erk, JNK, GSK, p38). However as these proteins might undergo functional regulation and changes, we hypothesized that the least regulated proteins (“housekeeping” proteins) might be a better normalization approach and corrected against the ⅓^{rd} of proteins with the least variation in expression intensities. Finally a validated approach is to normalize against the average of all proteins. All three approaches yielded similar results with correlation (R²) between 0.82-0.92. Sample distribution on unsupervised clustering of the 96 AML samples was identically for all three approaches. We usually stain 1-2 slides per arrays set with AB against our housekeeping proteins.

Alternatively if the absolute concentration of a protein does not need to be determined, building the ratio of the phospho over the corresponding total protein is another way to compare expression results amongst samples. Ratios factor out protein loading reflecting the change in the activity of proteins relative to the total amount of that particular protein. Either corrected numbers or ratio numbers can then be used for hierarchical clustering or other means of data analysis and representation.

Finally a new approach is proposed to overcome some of the normalization and quantification difficulties in proteomic analysis. As not all samples may have protein concentration or cell numbers available, a protein loading procedure needs to correct for potential uneven loading. Correcting each spot/sample for an average of 5-8 stable expressed proteins (housekeeping) or all proteins can factor out to a large part, printing, detection and staining variability before analyzing the data and still allow detection if total and phosphoprotein are regulated differentially. At the same time, this highlights the need for standardization of protein sample collection and processing. For the 96 AML samples presumably same cell numbers per volume were lysed for the last 10-15 years.

Statistical Analysis

This data set will be analyzed using programs and algorithms identical to those used for analysis of gene expression arrays. The data will be analyzed for the presence of clusters based on differential protein expression by a monethetic (binary variables) clustering method using statistical software. Chi-square test with continuity corrections will be used for statistical analysis. A variety of clustering methods (including hierarchical clustering, K-means, independent component analysis, mutual information, and gene shaving) will be used to classify the samples into statistically similar groups. The robustness and statistical significance of these groups will be evaluated by bootstrap resampling of the data. In addition, the drivers of this classification can be determined by analyzing the pathways activated using pathway analysis software (Ingenuity Syst., Mountain View, Calif.). The patient samples are linked to the Leukemia Sample Bank Database including patient characteristics (incl. cytogenetics, age gender, FAB type, prior hematological disorder, blast percent) and outcome data (response to therapy, type of therapy, remission duration etc). These data can be correlated with the RPPA clusters using standard statistical methods, including Fisher's exact test, analysis of variance, and Cox proportional hazards models for time to recurrence. In this way, we can determine if clusters of patient samples generated by RPPAs have clinical significance and correlate with specific endpoints such as cytogenetics, type of chemotherapy, etc. Adequate power to determine differences requires a “training set” of ˜80 patient samples and at least 120 patient samples as independent “test and validation sets.” It is important to emphasize that the 320 patient samples to be analyzed is larger than any analyzed by transcriptional profiling in any study providing high information content. The MDACC Leukemia Sample bank has more than sufficient numbers of liquid nitrogen stored patient samples and ready to use western blot lysates available for immediate processing (we have already identified 80-100 training and 240 test set samples).

Cytokine and Chemokine Expression in Aml and Mds Patient Samples

Methods according to certain embodiments of the present disclosure were used in conjunction with existing technology to test a large set of acute myeloid leukemia (AML) and myelodyspasia (MDS) patient samples for their cytokine and chemokine expression, and patterns of expression were determined and correlated with clinical outcomes. Protein expression and activation determines the pathophysiology of leukemic cells in Myelodysplasia (MDS) and Acute Myelogenous Leukemia (AML) and is dependent on endogenous changes (e.g. mutation, methylation) and exogenous signals from stromal interactions, cytokines (CTKN) and chemokines.

The level of 26 CTKN (IL-1RA, 1B, 2, 4 5, 6, 7, 8, 9, 10, 12, 13, 15, 17, Eotaxin, FGFB, G-CSF, GM-CSF, IFNγ, IP10, MCP1, MIP1α, MIP1β, PDGF, TNFα and VEGF) was measured using multiplex cytometry (Bioplex™, Biorad) in serum samples from 176 AML (138 untreated (New), 38 relapsed (REL)) and 114 MDS patients (97 New, 10 post biological therapy, 7 REL) and 19 normal (NL) subjects. Individual CTKN expression was not correlated with clinical features (e.g. age, gender, cytogenetics, FAB, HB, WBC, platelet etc). The levels of IL-1β, 4, 5, 6, 7, 10, 12, 13, 17, IFNγ, FGFB and MIP1α were significantly lower and IL-8 and 15 higher in AML/MDS compared to NL. The expression profiles of AML and MDS were statistically indistinguishable whether analyzed individually or by unsupervised hierarchical clustering, except for IL-8 and 13 (higher in AML) and VEGF (higher in MDS).

When CTKN were evaluated individually in new AML cases higher levels of IL4, 5 and 10 correlated significantly with remission attainment, and higher levels of IL8, Il1Ra, IP-10, Mip1β, VEGF and ILR, correlated significantly with shorter survival. No CTKN predicted remission attainment or survival in MDS. Unsupervised hierarchical bootstrap clustering using Pearson correlation and average linkage of CTKN expression relative to other CTKN expression, where high levels of one CTKN correlated with high expression of the other, revealed 6 highly reproducible expression patterns: 1) IL-1β 4, 7, 10, 12, 13, G-CSF, IFNβ, MIP1α and PDGF 2) IL 1ra, 6, 8 Eotaxin, IP-10, MIP1β and VEGF, 3) IL2, 9, 15 and GMCSF, 4) IL5 5) IL-7, FGF-Basic, TNFα and 6) MCP1.

Similar unsupervised clustering of the samples based on CTKN expression using average linkage also revealed 5 disease clusters and a NL sample cluster (containing all 19 NL samples). Average expression levels of each CTKN in these 5 clusters show diminished expression of most CTKN that had high expression in the NL samples, with each group showing increase in expression in a distinct subset of CTKN relative to NL. Remission attainment was strongly associated with cytokine signature (P=0.005). In summary, most CTKNs showed different expression in AML and MDS compared to NL; interestingly, CTKN expression in AML and MDS were similar; many CTKN are predictive of outcome individually; CTKN signatures distinguish groups of patients and are predictive of outcome; correlation with proteomic profiling may suggest CTKN to target in combination with other targeted therapies to maximally affect activated pathways.

RPPA Analysis and Associated Expression Signature Analysis

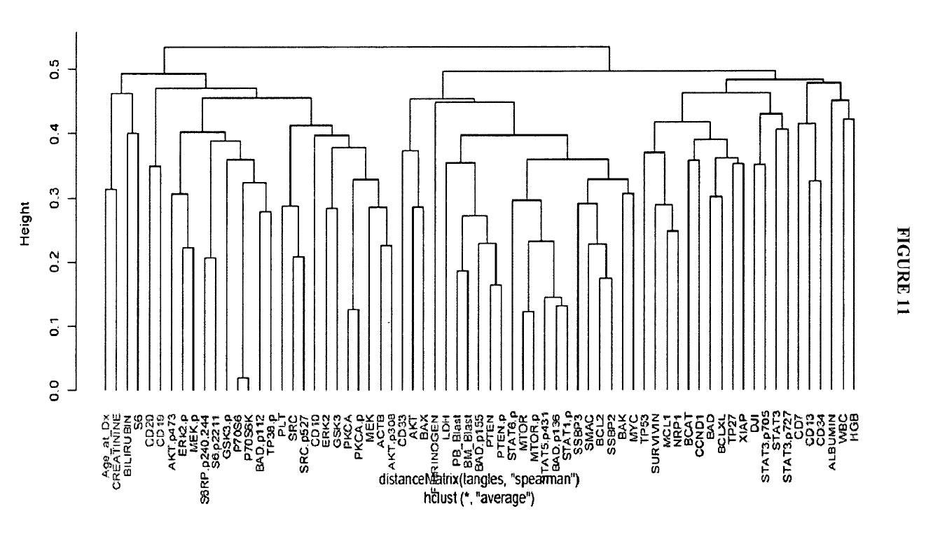

RPPA. A RPPA slide formatted as described above was used to analyze 550 patient samples with 52 proteins and phosphoproteins. The patient derived samples were whole cell lysates made from leukemia enriched CD3/CD19 depleted blood or marrow at a cell concentration of about 1×10⁴ cells per microliter. These samples were printed in replicate, one group in the spot designated by the “A,” and the other split on either side of that in a reversed orientation represented by the upside down “B.” For normalization, a positive control consisting of a mixture of 11 cell lines and a negative control consisting of the protein lysate buffer were used. For expression controls, 18 cell lines, including baseline and growth factor or cytokine stimulated versions shown on the schematic by the letter “C” and 18 normal peripheral blood samples, shown by the letter “N,” were used. To permit quantification of signal strength 138 purified peptides covering many of the proteins expected to measure, shown by the purple band encircling the patient samples, was included. A diagram illustrating the printing schematic is illustrated in FIG. 9.

The arrays were printed on an Aushon BioSytems 2470 arrayer using custom 175 micron pins. Each slide had 7968 dots printed. 5 serial 1 to 3 dilutions of each sample were printed, with the dots having an estimated ranged from about 85 cell equivalents of protein down to 1 cell equivalents of protein. At the end of each row of patient sample was printed either the positive or negative control. These create a grid across the whole slide, shown by the alternating red and black dots. FIG. 10 illustrates a representative slide created using this process.

Dilution-Concentration-Expression Curve and Expression Level Analysis. Protein expression intensity was measured with an automated software program called MicroVigene. The dilution series of the samples provide a dilution-concentration-expression curve giving numbers that can be read off the linear part of the curve and are used for data processing. FIG. 2 demonstrates such a curve. The data was standardized using topographical normalization and perturbation bootstrap validation/clustering was performed. This clustering method factors in randomness and errors and allows for correction of biases. This greatly increases the reliability and trustfulness of the data. A Bonferoni correction was also performed which accounts for the number of samples and proteins/antibodies when calculating statistical significance.

The protein expression levels in the leukemia enriched samples prepared from blood and marrow were analyzed. Overall clustering revealed no difference, but there were 8 of the 52 proteins with statistically significant differences. 4 were higher in blood and 4 higher in marrow. While the differences were statistically significant, the fold differences were all low. From this it can be concluded that blood and marrow samples can be used in the same analysis. The scale was normalized for the 8 proteins with differences. Table 3 illustrates the results of this analysis with respect to blood and marrow samples.

TABLE 3
Protein Expression Levels in Leukemia Enriched
Samples Prepared from Blood and Marrow
Protein Expressed Higher in Samples Prepared from Marrow

| Protein | Fold |
|---|---|
| pMTOR | 1.076 |
| pS6RP.p240-244 | 1.321 |
| S6.p2211 | 1.239 |
| Survivin | 1.071 |

Proteins Expressed Higher in Samples Prepared from Blood

| | |
|---|---|
| Protein | Fold |
| BAD | 1.070 |
| BAK | 1.051 |
| SRC | 1.154 |
| pSRCp527 | 1.169 |

Protein expression levels, shown in blue in FIG. 11, did not correlate with any of the traditional clinical correlates including age, gender, infection, performance status, or hematological parameters, shown as red in FIG. 11. As illustrated in FIG. 11, these criteria were separate on this cluster diagram.

Protein expression was different depending on disease status for 10% of the 52 proteins. Expression of ten proteins differed between newly diagnosed and relapsed. These included: pAKTp308, BCL2, pERK2, MTOR, pMTOR, PTEN, pPTEN, SMAC, pSRC.p527, and SSBP2.

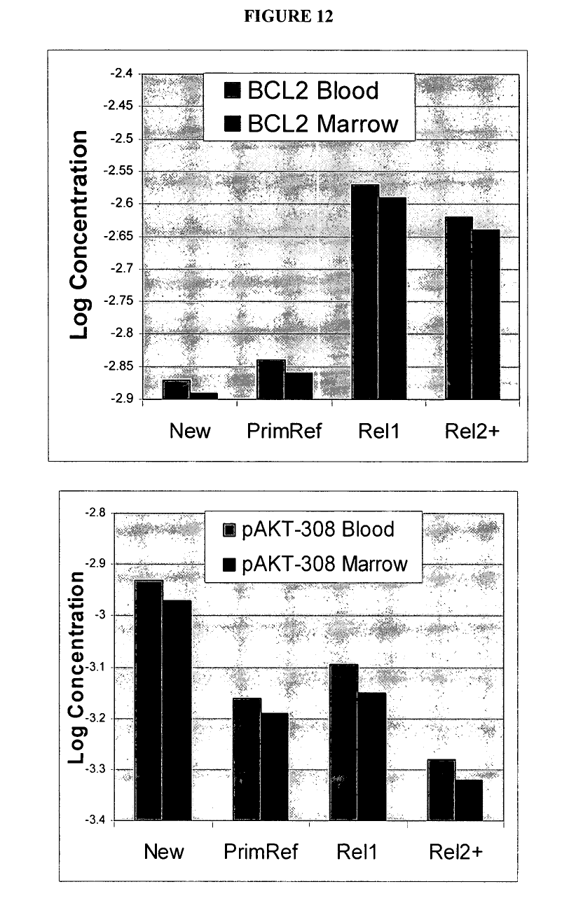

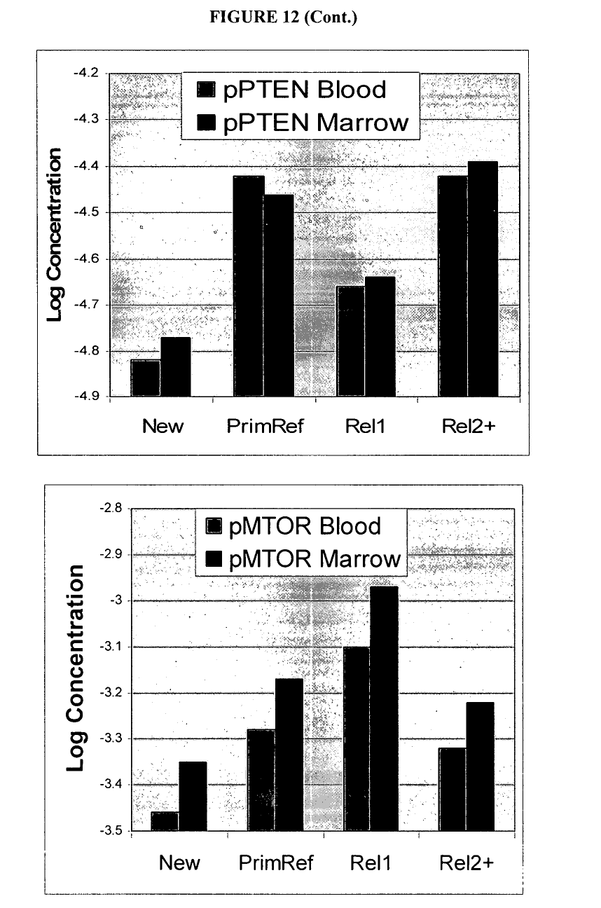

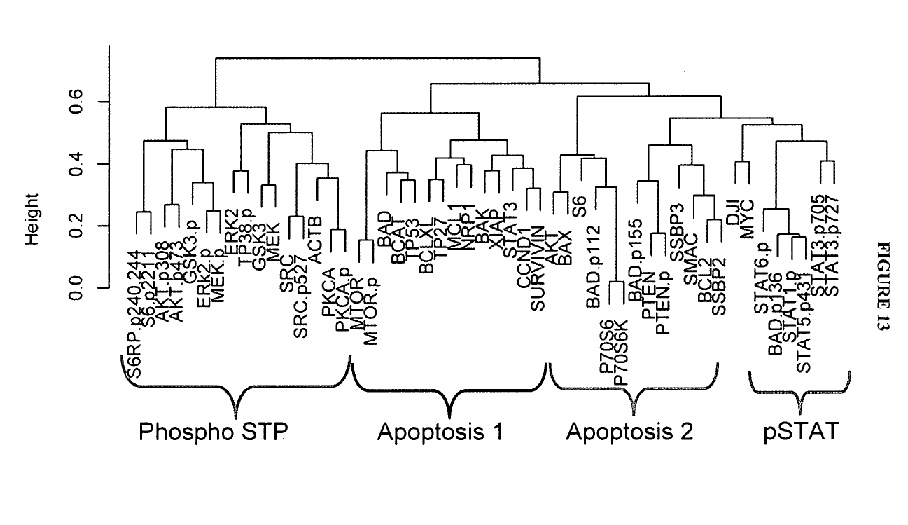

FIG. 12 shows the mean levels of protein expression for particular proteins organized by disease status, going from newly diagnosed to, primary refractory first relapse and second or greater relapse. Various patterns were present with some proteins increasing with increasing resistance and others decreasing. In some cases, the greater change was between new and relapse, in others between new and primary refractory. This suggests that relevance of some proteins changes during the evolution of leukemia, and this may affect whether agents targeting these proteins are more or less likely to be effective.

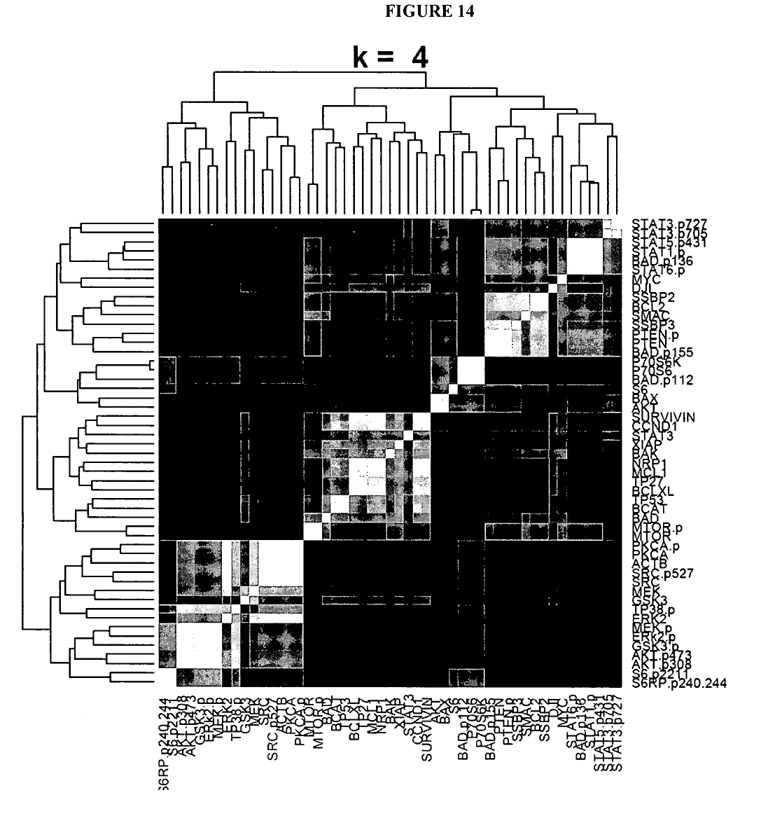

FIG. 13 shows unsupervised clustering of protein expression levels. Unsupervised clustering revealed 4 clusters. The first was composed mostly of phosphorylated STP, the second and third mainly of apoptosis related proteins and the last of phosphorylated stat proteins.

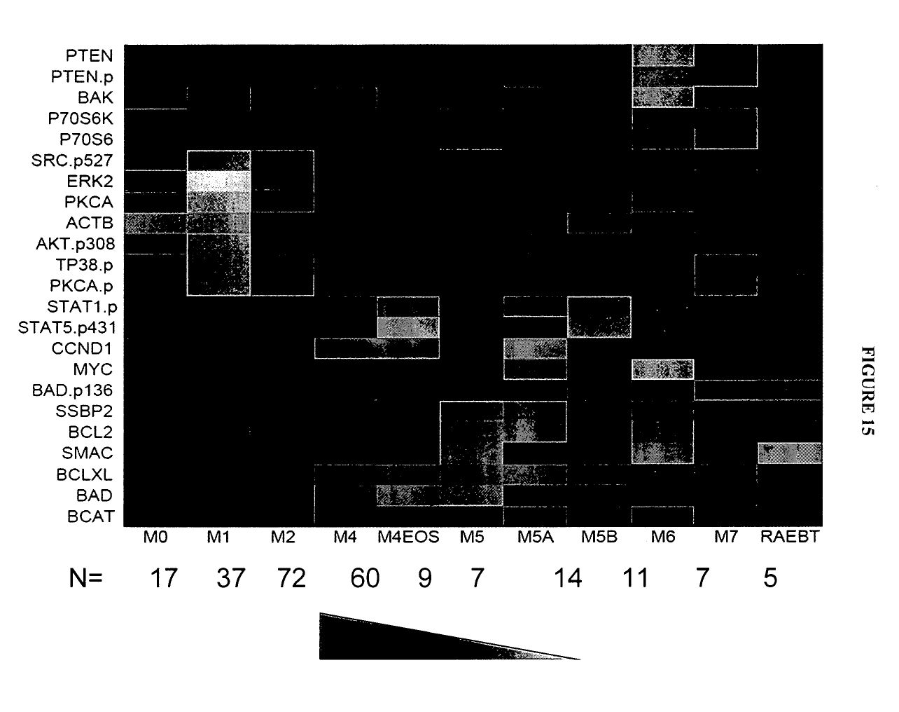

Bootstrap clustering was performed and showed that these four clusters were highly reproducible, as shown in FIG. 14. Bright yellow indicates 100% correlation and pure blue shows that 2 proteins are never correlated.

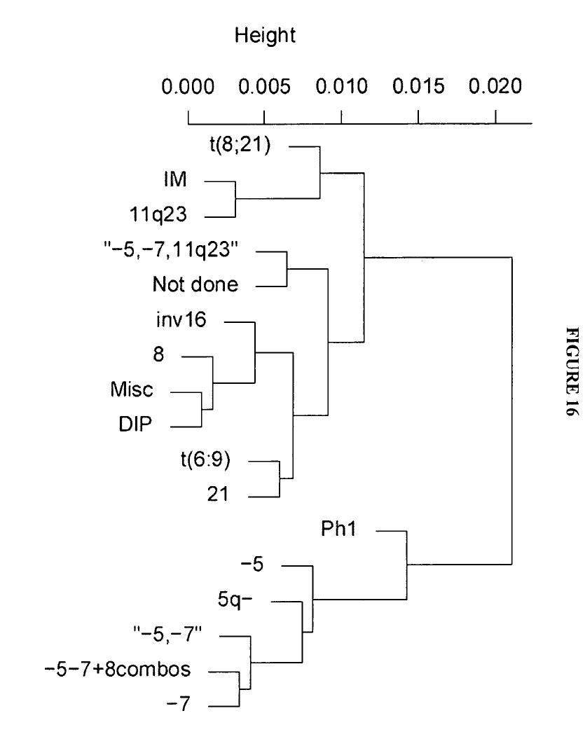

FAB Classification. Protein expression levels were then evaluated across FAB classification. Significant differences were noted for 23 proteins. As shown in FIG. 15, the protein expression signatures of these 23 proteins could be used to classify patients. This data may be used to suggest when to use targeted therapies. For example, it may be desired to selectively use an anti-BCL2 agent in M0, M1 and M2 where levels are high, and not in other FAB classifications where it is already low.

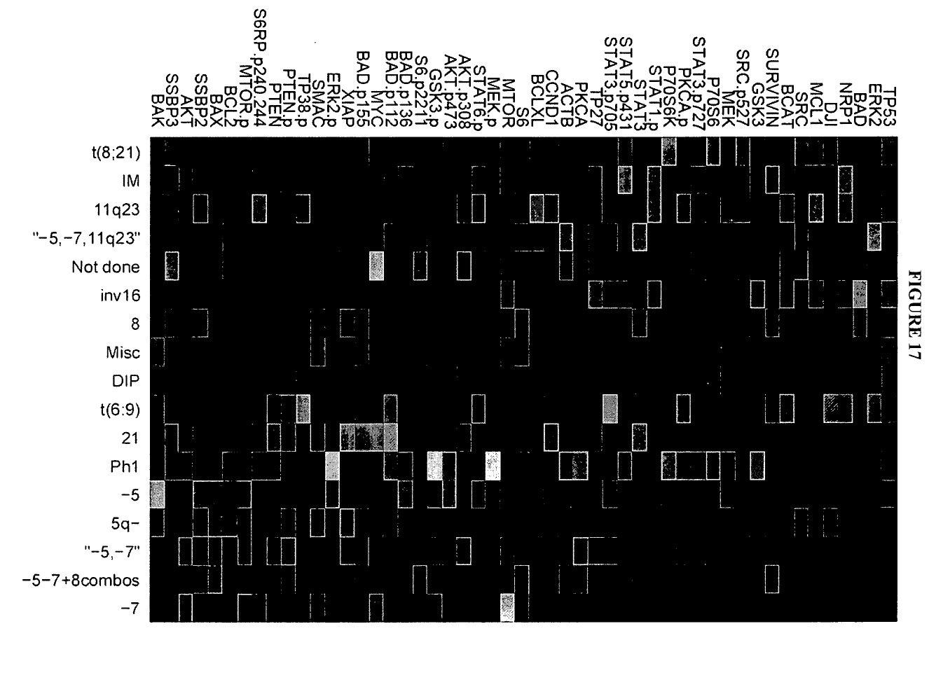

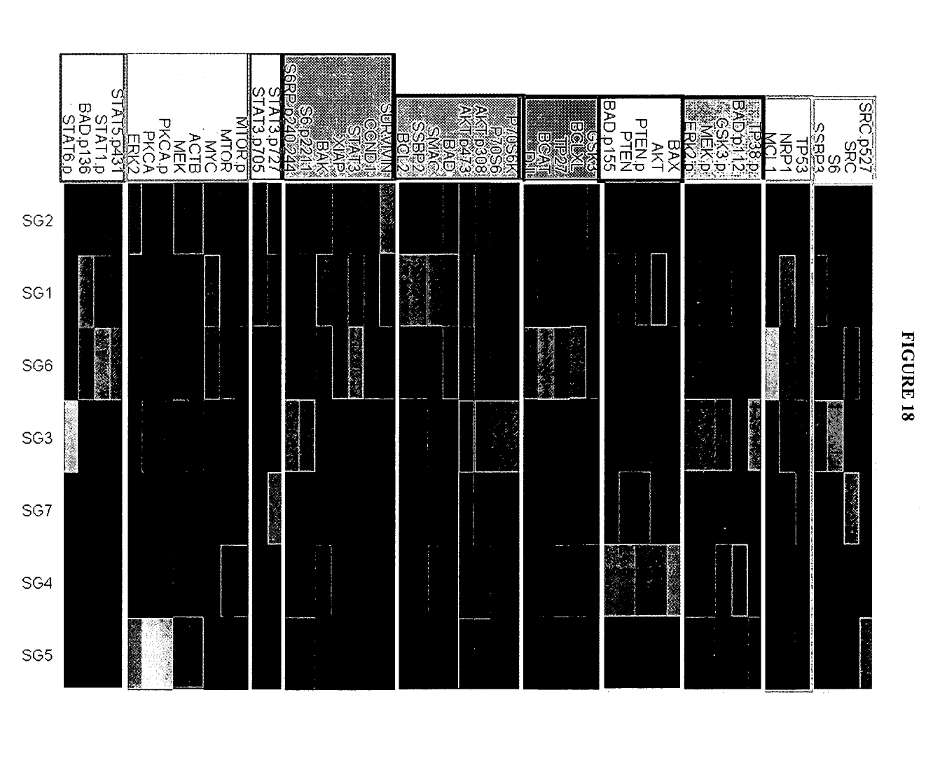

Cytogenetics. Protein expression signatures were further evaluated in the context of cytogenetics (FIG. 16). A patient again could be clustered with different protein signatures being associated with particular cytogenetic changes. Of note, to the right side of FIG. 16, all of the changes involving chromosomes 5 and 7, individually or in combination, were found in the same cluster, with the exception of those with an 11q23 abnormality. Notably, favorable cytogenetic changes inversion 16 and translocation 8 21, which both affect core binding factor did not cluster with each other. FIG. 17 shows a heat map shows the average level of protein expression by cytogenetic category, arrayed in the same order as the prior dendogram. As might be expected, diploids, and miscellaneous likely representing a polyglot of changes, had median expression for most proteins. FIG. 17 suggest that targeted therapies need to be applied selectively to those cytogenetics categories where expression or activation of that particular protein is found. For example, agents like nutlins would not be likely to be effective incases with a −5 or −7 where p53 levels are very high.

Principal component clustering, based on the absolute value of Pearson correlation, was used to define proteins clusters. This initially suggested 10 clusters. The total score or “signature” for a patient was determined by taking the sum of the score for each protein cluster. To define a protein signature, the score for each cluster for each patient was determined and an overall vector determined. When patients were clustered based on this overall score, 7 proteins signature groups emerged.

FIG. 18 illustrates a heat map showing the average signal of each proteins within the 7 protein signature clusters. The components of the 10 protein clusters and average expression of each protein in each group are shown. In some groups the proteins all generally show positive correlation, while in other groups there are protein with both positive and negative correlation. This demonstrates that there are unique recurrent patterns or signatures served in AML.

Within these 7 protein signature clusters patients were not evenly divided on the basis of cytogenetics. Table 4 shows how patients within a cytogenetic group were divided among the 7 signatures. Some groups had over representation, or under representation, within a group.

TABLE 4
Cytogenetics Unevenly Distributed
Within Protein Signature Groups

| | | | |
|---|---|---|---|
| Group | Favorable | Intermediate | Unfavorable |

| | | | |
|---|---|---|---|
| 1 | 22.7% | 23.5% | 20.2% |
| 2 | 9% | 12.1% | 10% |
| 3 | 4.5% | 7.3% | 10% |
| 4 | 4.5% | 8.9% | 16% |
| 5 | 18.2% | 29.2% | 18.4% |
| 6 | 31.8% | 16.2% | 7.5% |
| 7 | 9% | 2.4% | 17.6% |

Table 5 shows the response rate when patients are stratified by protein cytogenetics. Since all the favorable cytogenetic patients achieved remission the signature was not informative, however the remission rate varied greatly for both intermediate and unfavorable prognosis cytogenetics depending on the proteins expression signature. The same stratification of patients by protein signature and cytogenetics was used to analyze relapse rates. This revealed that protein signatures are associated with markedly different relapse rates within cytogenetic groupings. Table 6 below illustrates these findings.

TABLE 5
Response Rate By Protein Signature Group And Cytogenetics

| Group | Favorable | Intermediate | Unfavorable |
|---|---|---|---|
| 1 | 100% | 78% | 42% |
| 2 | 100% | 71% | 50% |
| 3 | 100% | 71% | 50% |
| 4 | 100% | 30% | 53% |
| 5 | 100% | 59% | 35% |
| 6 | 100% | 63% | 75% |
| 7 | 100% | 0% | 37% |

TABLE 6
Relapse Rate By Protein Signature Group And Cytogenetics

| | | | |
|---|---|---|---|
| Group | Favorable | Intermediate | Unfavorable |

| | | | |
|---|---|---|---|
| 1 | 60% | 34% | 63% |
| 2 | 50% | 60% | 40% |
| 3 | 0% | 20% | 80% |
| 4 | 0% | 33% | 63% |
| 5 | 50% | 50% | 67% |
| 6 | 29% | 75% | 0% |
| 7 | 50% | NA | 100% |

Protein Expression Signatures are Prognostic

73 AML patents were evaluated using the methods according to certain embodiments of the present disclosure. 22 proteins and 15 phosphoproteins were measured. Distinct protein expression signatures existed and were prognostic. Differing response rates and differing relapse rates were present. The response rate, primary refractory or resistance rate and the rate of relapse for each signature group is shown in Table 7. While CR and resistance rates differed across the groups, the overall relapse rate was similar in all groups except group 7.

Within these 7 protein signature clusters, patients were not evenly divided on the basis of cytogenetics. Table 8 shows the percentage of each signature made up by each of the 3 large cytogenetic groups. Some groups had over representation shown in red, or under representation, shown in yellow within a group.

TABLE 7
Cr, Resistance And Relapse Rates By Group

| | | | % Fail + | |
|---|---|---|---|---|
| Group | # | % CR | Resistant | % Relapse |
| 1 | 47 | 66 | 34 | 45 |
| 2 | 27 | 66 | 34 | 50 |
| 3 | 18 | 61 | 39 | 45 |
| 4 | 26 | 46 | 54 | 50 |
| 5 | 55 | 54.5 | 45.5 | 53 |
| 6 | 30 | 73 | 26.6 | 50 |
| 7 | 21 | 47.6 | 53.4 | 80 |

TABLE 8
Cytogenetics Unevenly Distributed
Within Protein Signature Groups

| Group | Favorable (%) | Intermediate (%) | Unfavorable (%) |
|---|---|---|---|
| 1 | 8.6 | 50 | 41.4 |
| 2 | 6.7 | 50 | 40% |
| 3 | 4.5 | 40.9 | 54.5 |
| 4 | 3.2 | 35.5 | 61.3 |
| 5 | 6.3 | 57.1 | 34.9 |
| 6 | 19.4 | 55.6 | 25 |
| 7 | 10.7 | 7.1 | 75 |

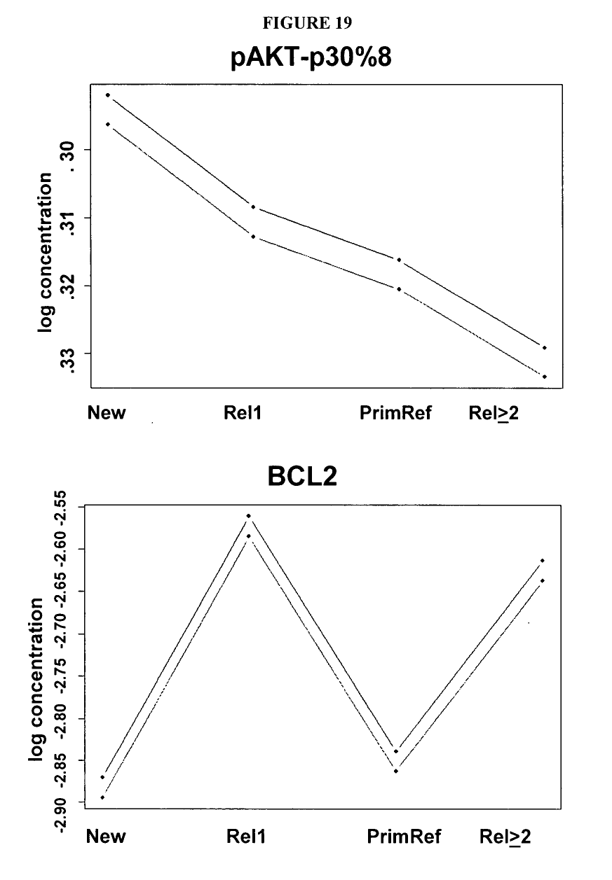

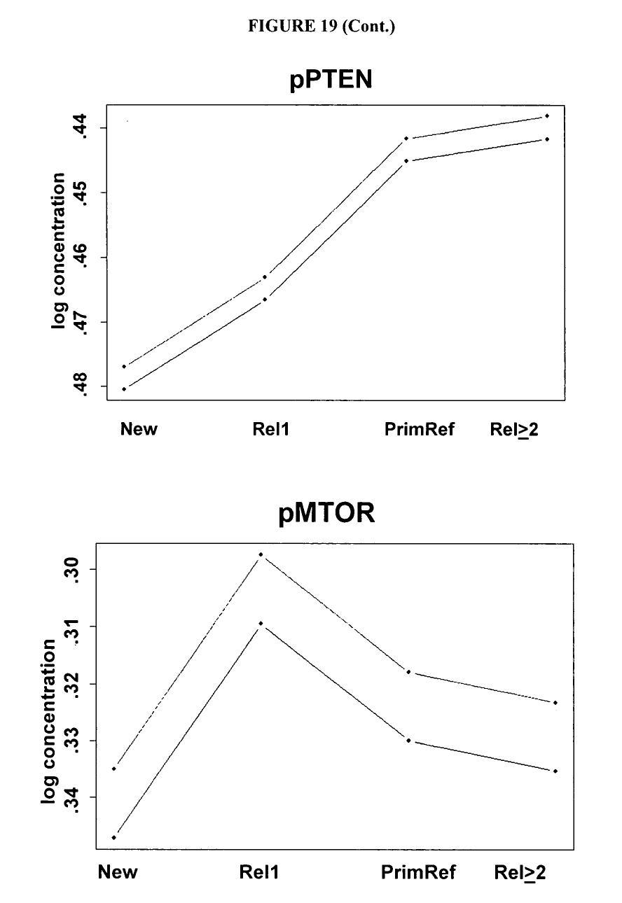

FIG. 19 shows the mean levels by disease status, going from newly diagnosed to first relapse, primary refractory and second or greater relapse. Blue lines are blood and red are marrow. You can see that various patterns were present with some proteins increasing with increasing resistance and others decreasing. In some cases, the greater change was between new and relapse, in others between new and primary refractory. This may suggest changing importance of certain proteins during the evolution of leukemia and may affect when agents targeting these proteins are more or less likely to be effective.

Thus, RPPA expression arrays define distinct protein expression signatures associated with: FAB, cytogenetics, response rates, resistance, and relapse rates. Signatures may guide targeted therapy to settings where greater efficacy may occur.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Therefore, the present invention is well adapted to attain the ends and advantages mentioned as well as those that are inherent therein. While numerous changes may be made by those skilled in the art, such changes are encompassed within the spirit of this invention as illustrated, in part, by the appended claims.

What is claimed is:

1. A protein activation and expression signature formed by a process comprising: assaying a plurality of samples with a protein array; clustering the assayed samples based on patterns; and generating a heat map.

2. The method of claim 1 wherein the protein array is a reverse phase protein microarray.

3. A method for preparing a protein expression and activation signature comprising: obtaining a protein sample from a patient; obtaining one or more of a protein expression level and a phosphorylation level corresponding to a protein being measured; clustering samples based on patterns of one or more of expression levels or phosphorlation levels; and generating a heat map using the clustering and the proteins being measured.

4. The method of claim 3 wherein obtaining one or more of a protein expression level and a phosphorylation level comprises assaying the samples using a reverse phase protein microarray.

5. A method for analyzing a sample comprising: comparing a protein expression level or a phosphorylation level or both in a cell sample from a cancer patient to at least one reference protein expression and activation signature, wherein the difference or similarity between the protein expression level or a phosphorylation level or both of the patient and the at least one reference protein expression and activation signature is indicative of prognosis of the cancer in the patient.

6. The method of claim 5, wherein protein is selected from signal transduction pathway (STP) proteins, apoptosis regulating proteins, cell cycle regulating proteins, cytokines, and chemokines.

7. A system comprising: a first storage medium including data that represent a protein expression level or a phosphorylation level or both of one or more proteins in a cell sample of a patient; a second storage medium including data that represent at least one reference protein expression and activation signature; a program capable of comparing the protein expression level or a phosphorylation level or both to the at least one reference protein expression and activation signature; and a processor capable of executing the program.

8. A microarray comprising a plurality of samples or sets of samples, a positive control, and a negative control, wherein the samples or sets of samples are arrayed on the slide and each sample or set of samples is associated with a positive control or with a negative control or both.

9. A method for normalizing a signal from a microarray comprising generating a three-dimensional topographical map from a plurality of signals and correcting irregularities found in the three-dimensional topographical map, wherein the plurality of signals is from one or more of a negative control and a positive control.

10. A method for assessing cancer prognosis and treatment of cancer comprising: providing cancer cell samples from a newly diagnosed patient and from other patients in different stages of the disease; assaying the samples with a protein array; comparing the results the assay across the cells samples to assess cancer prognosis; and devising an individualized treatment regimen for the newly diagnosed patient based.

11. The method of claim 10 wherein the cancer cell is derived from a solid tumor, metastatic cancer, or non-metastatic cancer, Acute Myelogenous Leukemia, Acute Lymphocytic Leukemia, Chronic Lymphocytic Leukemia, Myelodysplasia, myeloma, and lymphoma.

12. A method of classifying a biological sample with respect to a phenotypic effect, comprising: determining a protein expression and activation profile of a cell sample, wherein the protein expression and activation profile is correlated with a phenotypic effect; and classifying the sample with respect to phenotypic effect.

13. The method of claim 12 wherein the phenotypic effect correlates with prognosis of a disease.
